(19) United States
(12) Patent Application Publication
(10) Pub. No.: US 2013/0223368 A1
(43) Pub. Date: Aug. 29, 2013

(54) METHOD FOR TRANSMITTING DATA USING VARIABLE CLOCK

(71) Applicant: Electronics and Telecommunications Research Institute, (US)

(72) Inventors: Yong Sun KIM, Daejeon (KR); Seung Eun Hong, Daejeon (KR); Jin Kyeong Kim, Daejeon (KR); Woo Yong Lee, Daejeon (KR)

(73) Assignee: Electronics and Telecommunications Research Institute, Daejeon (KR)

(21) Appl. No.: 13/778,219

(22) Filed: Feb. 27, 2013

(30) Foreign Application Priority Data
Feb. 27, 2012 (KR) 10-2012-0019574
May 3, 2012 (KR) 10-2012-0046615

(51) Int. Cl. H04W 52/02

(52) U.S. Cl. CPC H04W 52/0209
USPC 370/329

(57) ABSTRACT

A data transmission system that transmits data in a wireless environment such as a wireless communication network is provided. The data transmission system includes an access point (AP) and a terminal. The AP transmits control information to the terminal, and the terminal selects a data period to transmit the data based on the control information. The terminal may determine an operation clock, a channel bandwidth, and the like according to a data transmission rate of the data to be transmitted. The terminal may operate at a low operation clock according to the data transmission rate, thereby reducing power consumption.

### CROSS-REFERENCE TO RELATED APPLICATION

This application claims the benefit of Korean Patent Applications No. 10-2012-0019574, filed on Feb. 27, 2012, and No. 10-2012-0046615, field on May 3, 2012, in the Korean Intellectual Property Office, the disclosure of which is incorporated herein by reference.

### BACKGROUND

1. Field of the Invention

The present invention relates to a data transmission technology in a wireless environment such as a wireless communication network, and more particularly, to a technology for reducing power consumption by varying an operation clock according to a data transmission rate.

2. Description of the Related Art

Generally, conventional near field communication (NFC) devices such as a wireless local area network (LAN) or a wireless communication network reduce transmission power through power control or switch to a standby mode or hibernate mode when not performing communication. However, in the NFC devices, the same operation clock and the same channel bandwidth are used regardless of a level of data transmission rate. Therefore, with respect to the same transmission power, excessively high power may be wasted to transmit data at a low data transmission rate.

It is generally known that power consumption is proportional to the operation clock and also to the square of operation power. Therefore, the operation power may be reduced by reducing the operation clock. Usually, the operation clock is set to support a high data transmission rate and in consideration of the channel bandwidth. To support a low data transmission rate using the operation clock, a modulation method having a relatively low bit rate, such as binary phase shift key (BPSK), may be used. Alternatively, the transmission rate may be reduced while increasing a transmission distance, by reducing a coding rate of channel coding such as Reed-Solomon (RS) coding, convolution coding, low-density parity check (LDPC) coding, and the like.

However, although widely used, the foregoing methods are not much efficient in view of power consumption. Furthermore, the channel bandwidth is used as if the transmission rate were high though data is transmitted actually at a low transmission rate. In addition, when the transmission power is directly controlled according to the communication distance, an algorithm for periodically receiving feedback from an opposite party and controlling the feedback is necessary, thereby causing a high overhead.

### SUMMARY

An aspect of the present invention provides a method for transmitting data with relatively low power consumption.

Another aspect of the present invention provides a data transmission method for efficiently using wireless resources by controlling a bandwidth of data being transmitted.

According to an aspect of the present invention, there is provided an operation method of a terminal that transmits data through a wireless communication network, the operation method including securing a channel band of the wireless communication network according to a data transmission rate of data to be transmitted through the wireless communication network; and transmitting the data using the channel band.

The channel band may be proportional to the data transmission rate.

The operation method may further include determining an operation clock proportional to the data transmission rate, wherein the transmitting comprises transmitting the data at the operation clock.

The operation method may further include determining a modulation method according to the data transmission rate; and modulating the data according to the modulation method, wherein the transmitting may include transmitting the modulated data.

According to another aspect of the present invention, there is provided a method of operating a terminal that transmits data through a wireless communication network, the method including receiving a data frame including a beacon period from an access point (AP); determining whether to transmit the data in a data period included in the data frame by decoding information on users included in the beacon period; determining a data transmission rate of the data and an operation clock in the data period, the operation clock proportional to the data transmission rate, based on the information on users when transmitting the data; and transmitting the data to the AP in the data period according to the data transmission rate and the operation clock in the data period.

In the beacon period, the terminal may operate according to the operation clock of the beacon period. The operation clock in the data period may be a positive number times the operation clock in the beacon period.

In addition, the operation clock in the data period may be the same as an operation clock of a second terminal that transmits second data to the AP in the data period.

The operation method may further include determining a modulation method according to the data transmission rate; and modulating the data according to the modulation method, wherein the transmitting may include transmitting the modulated data.

The transmitting may include transmitting the data with a bandwidth proportional to the data transmission rate.

The data frame may include a plurality of data periods. The determining may include determining a data period among the plurality of data periods to transmit the data based on the data transmission rate.

According to another aspect of the present invention, there is provided an operation method of an AP that receives data through a wireless communication network, the operation method including transmitting a data frame including a beacon period and a data period to a terminal; and receiving the data transmitted in the data period with a data transmission rate determined based on information on users included in the beacon period and at an operation clock determined based on the information on users to be proportional to the data transmission rate.

The receiving may include receiving the data with a bandwidth proportional to the data transmission rate.

The transmitting may include additionally transmitting the data frame to the second terminal. The receiving may include receiving the second data transmitted from the second terminal with the data transmission rate.

The data may be modulated by a modulation method determined according to the data transmission rate.

The data frame may include a plurality of data periods. When the data transmission rate of the terminal and the data transmission rate of the second terminal are different, the receiving may include receiving the data and the second data during the different data periods among the plurality of data periods.

### EFFECT

According to embodiments of the present invention, there is provided a method of transmitting data with low power consumption.

Additionally, according to embodiments of the present invention, a data transmission method may efficiently use wireless resources by controlling a bandwidth of data to be transmitted.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a structure of a data frame according to an embodiment of the present invention;

FIG. 2 is a diagram illustrating matching relationships between an operation clock and a bandwidth, according to an embodiment of the present invention;

FIG. 3 is a diagram illustrating a data transmission rate according to an embodiment of the present invention;

FIG. 4 is a diagram illustrating a bandwidth of a channel band, according to an embodiment of the present invention;

FIG. 5 is a diagram illustrating a structure of a data frame including a plurality of data periods, according to an embodiment of the present invention;

FIG. 6 is a diagram illustrating a data period map according to an embodiment of the present invention;

FIG. 7 is a flowchart illustrating steps of a terminal operation method according to an embodiment of the present invention;

FIG. 8 is a flowchart illustrating steps of a terminal operation method according to another embodiment of the present invention; and

FIG. 9 is a flowchart illustrating steps of an operation method of an access point (AP), according to an embodiment of the present invention.

FIG. 10 is a block diagram illustrating a structure of a terminal according to another embodiment of the present invention.

FIG. 11 is a block diagram illustrating a structure of an AP according to an embodiment of the present invention.

FIG. 12 is a diagram illustrating a wireless resource allocation system according to an embodiment of the present invention.

FIG. 13 is a flowchart illustrating steps of a wireless resource allocation method according to an embodiment of the present invention.

FIG. 14 is a diagram illustrating a structure of a data frame according to an embodiment of the present invention.

FIG. 15 is a diagram illustrating a structure of a data frame including an interference measurement period, according to an embodiment of the present invention.

FIG. 16 is a diagram illustrating a structure of a data frame including an interference measurement period, according to an embodiment of the present invention.

FIG. 17 is a diagram illustrating a structure of a data frame to which overlapped wireless resources are allocated, according to an embodiment of the present invention.

FIG. 18 is a diagram illustrating an interference measurement period and an interference report period included in a data frame to which overlapped wireless resources are allocated, according to an embodiment of the present invention.

FIG. 19 is a block diagram illustrating a structure of an access point according to an embodiment of the present invention.

FIGS. 20 and 21 are a block diagram illustrating a structure of a terminal according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout.

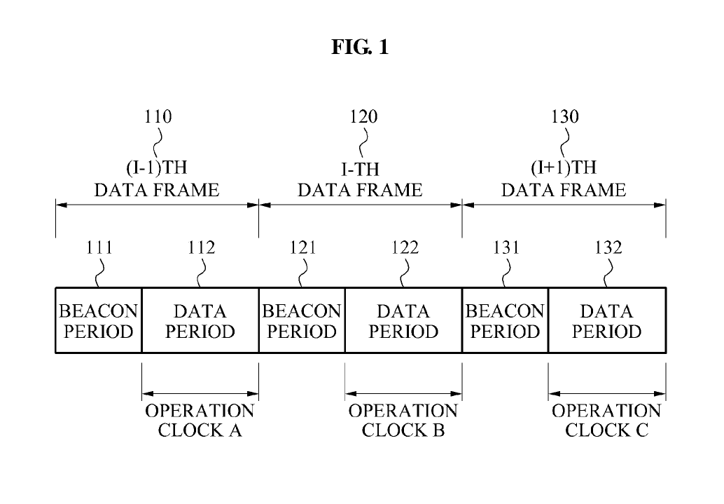

FIG. 1 is a diagram illustrating a structure of a data frame according to an embodiment of the present invention.

An (i−1)th data frame 110 includes a beacon period 111 and a data period 112. An i-th data frame 120 includes a beacon period 121 and a data period 122. An (i+1)th data frame 130 includes a beacon period 131 and a data period 132.

The beacon periods 111, 121, and 131 refer to time periods for an access point (AP) to transmit control information to a terminal. The data periods 112, 122, and 132 refer to time periods for the terminal to transmit data to the AP.

The AP may transmit control information to the terminal using the beacon periods 111, 121, and 131. The terminal may controls operation clocks according to the control information, thereby transmitting the data to the AP in the respective data periods 112, 122, and 132. According to an aspect, the terminal may operate at an operation clock A in the data period 112, at an operation clock B in the data period 122, and at an operation clock C in the data period 132.

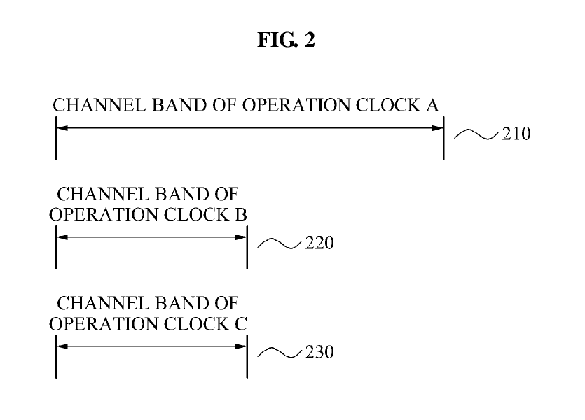

FIG. 2 is a diagram illustrating matching relationships between an operation clock and a bandwidth, according to an embodiment of the present invention.

According to an aspect, a terminal may operate at an operation clock determined according to the respective data periods 112, 122, and 132. In this case, the terminal may secure a channel band corresponding to the operation clock and transmit data to an AP using the secured channel band.

When the terminal operates at the operation clock A in the data period 112, the terminal may secure a channel band 210 and transmit the data to the AP using the channel band 210.

When the terminal operates at the operation clock B in the data period 122, the terminal may secure a channel band 220 and transmit the data to the AP using the channel band 220.

When the terminal operates at the operation clock C in the data period 132, the terminal may secure a channel band 230 and transmit the data to the AP using the channel band 230.

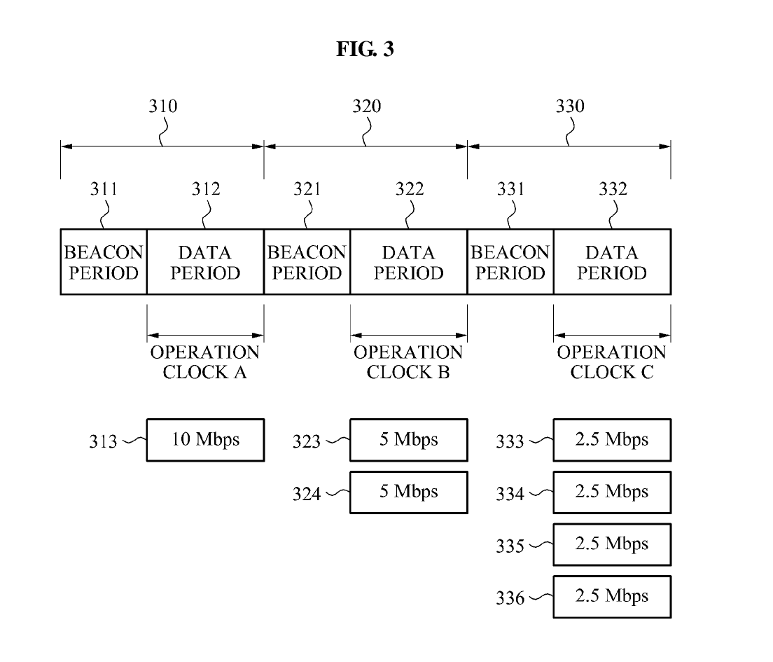

FIG. 3 is a diagram illustrating a data transmission rate according to an embodiment of the present invention.

Data frames 310, 320, and 330, beacon periods 311, 321, and 331, and data periods 312, 322, and 323 shown in FIG. 3 are similar to the data frames 110, 120, and 130, the beacon periods 111, 121, and 131, and the data periods 112, 122, and 132 and therefore will not be described in detail.

In the first data period 112, a terminal may operate at an operation clock A and transmit data to an AP at about 10 Mbps of data transmission rate. In the second data period 122, the terminal may operate at an operation clock B and transmit the data to the AP at about 5 Mbps of data transmission rate. In the third data period 132, the terminal may operate at an operation clock C and transmit the data to the AP at about 2.5 Mbps of data transmission rate.

According to an aspect, the operation clocks of the terminal and the data transmission rates may be proportional to each other. That is, the operation clock A of the terminal in the first data frame 112 may be double the operation clock B of the terminal in the second data frame 122. Also, the operation clock B of the terminal in the second data frame 122 may be double the operation clock C of the terminal in the third data frame 132.

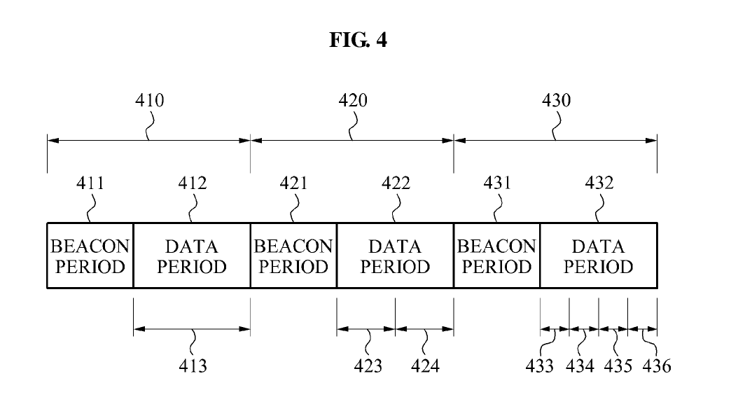

FIG. 4 is a diagram illustrating a bandwidth of a channel band, according to an embodiment of the present invention.

Data frames 410, 420, and 430, beacon periods 411, 421, and 431, and data periods 412, 422, and 423 shown in FIG. 4 are similar to the data frames 110, 120, and 130, the beacon periods 111, 121, and 131, and the data periods 112, 122, and 132 and therefore will not be described in detail.

In the first data period 412, a terminal may transmit data to an AP using a first channel band 413. In the second data period 422, the terminal may transmit the data to the AP using second channel bands 423 and 424. In the third data period 432, the terminal may transmit the data to the AP using third channel bands 433, 434, 435, and 436.

According to an aspect, the operation clocks of the terminal and bandwidths may be proportional to each other. That is, when the operation clock A of the first data period 412 is double the operation clock B of the second data period 422, a bandwidth of the first channel band 413 of the terminal in the first data period 412 may be double bandwidths of the second channel bands 423 and 424 of the terminal in the second data period 422.

When operation clock B of the second data period 422 is double the operation clock C of the third data period 432, a bandwidth of the second channel bands 423 and 424 of the terminal in the second data period 422 may be double bandwidths of the third channel bands 433, 434, 435, and 436 of the terminal in the third data period 432.

As described with reference to FIGS. 2 to 4, the terminal may operate at different operation clocks depending on the data periods, or secure different bandwidths to transmit data.

According to another aspect, the terminal may determine the operation clock or the bandwidth in the respective data periods based on the data transmission rate of the data to be transmitted to the AP. The terminal may determine the operation clock according to the data transmission rate and operate according to the operation clock. Also, the terminal may determine the bandwidth according to the data transmission rate and transmit the data using the bandwidth.

When the data transmission rate of the data to be transmitted by the terminal is low, the terminal may determine to use a low operation clock. When the terminal operates at a low operation clock, the terminal may reduce power consumption.

When the data transmission rate of the data to be transmitted by the terminal is low, the terminal may determine to transmit the data with a narrow bandwidth. In this case, the terminal may secure only a narrow bandwidth. Referring to FIG. 4, when the terminal secures only the narrow bandwidth, the terminal may share a frequency band allocated to the data period 432 with another terminal. For example, when the terminal uses one channel band 433, the other terminals may use other channel bands 434, 435, and 436.

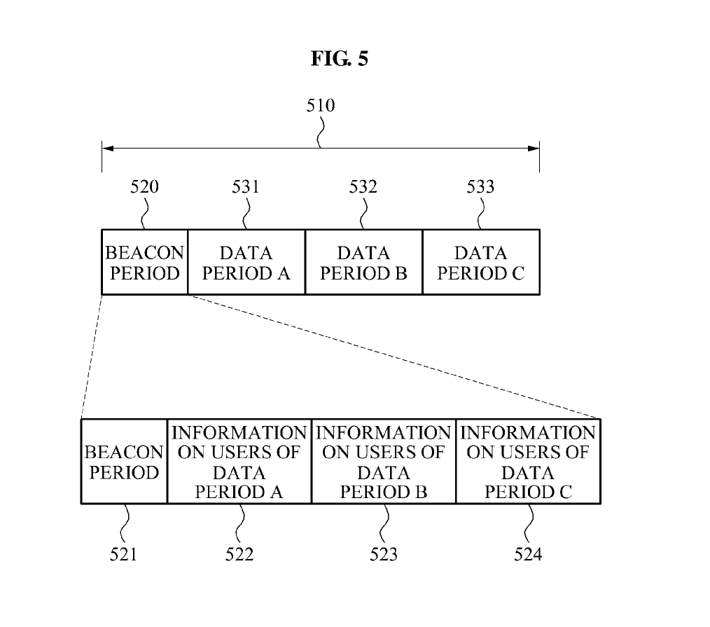

FIG. 5 is a diagram illustrating a structure of a data frame including a plurality of data periods, according to an embodiment of the present invention.

A data frame 510 may include one beacon period 520 and a plurality of data periods 531, 532, and 533. The data periods 531, 532, and 533 may refer to time periods for a terminal to transmit data to an AP. The beacon period 520 may refer to a time period for the AP to transmit control information to the terminal.

As shown in FIG. 5, when the plurality of data periods 531, 532, and 533 are included in one data frame 510, the beacon period 520 may transmit the control information related to the data periods 531, 532, and 533, respectively.

According to an aspect, the beacon period 520 may include a region 521 that includes information on start and end of each period, and regions 522, 523, and 524 that include information on users who transmit data in the respective data periods 531, 532, and 533.

According to an aspect, the region 521 including the information on start and end of each period may include information on a start time point and an end time point of each of the regions 522, 523, and 524 including the information on the users transmitting the data in the data periods 531, 532, and 533.

In addition, the regions 522, 523, and 524 including the information on the users transmitting the data in the respective data periods 531, 532, and 533 may include information on a data transmission rate of the users transmitting the data in the data periods 531, 532, and 533.

The terminal may receive information on the users transmitting the data in the data periods 531, 532, and 533, and determine one of the data periods 531, 532, and 533 to transmit the data according to the data transmission rate of the data to be transmitted.

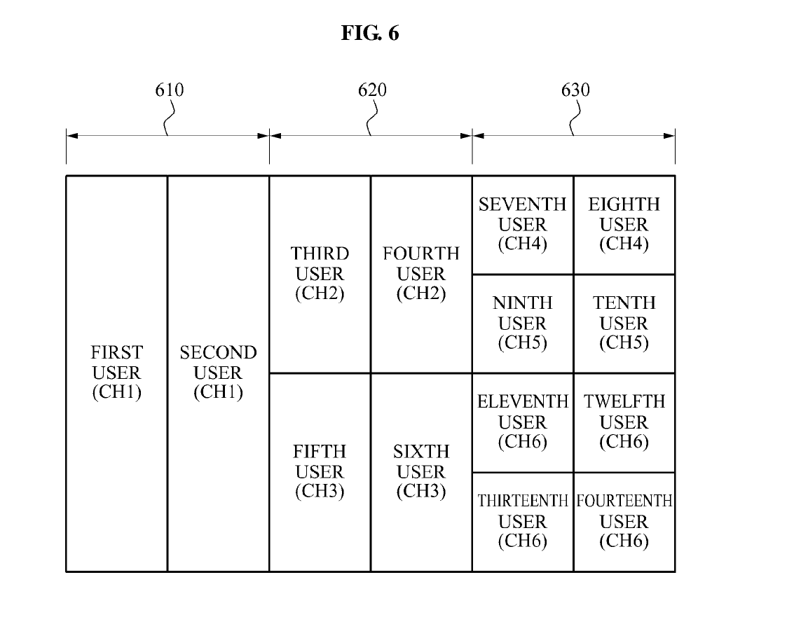

FIG. 6 is a diagram illustrating a data period map according to an embodiment of the present invention.

In FIG. 6, a horizontal axis denotes time and a vertical axis denotes a channel bandwidth.

A data period A 610 may include two users in one channel band. A data period B 620 may include four users in two channel bands. A data period C 630 may include eight users in four channel bands.

A channel bandwidth of the data period A 610 is large enough to cover the entire channel band. A channel bandwidth of the data period B 620 is a half the channel bandwidth of the data period A 610. A channel bandwidth of the data period C 630 is a half the channel bandwidth of the data period B 620.

According to an aspect, a channel 1 CH1 refers to a case in which the entire bandwidth is used as in the data period A 610. Channels 2 and 3 CH2 and CH3 refer to cases in which a half bandwidth is used as in the data periods B 620. In addition, when a quarter of the entire bandwidth is used as in the data period C 630, a number of channels is increased as shown in FIG. 6.

According to the embodiment shown in FIG. 6, when the data transmission rate is low, the terminal may select the data period C 630 rather than the channel A 610. When the terminal transmits data in the data period C 630, channel use efficiency may be higher than when the data is transmitted in the data period A 610.

Conversely, when the data transmission rate needs to be high, the terminal may select the data period A 610.

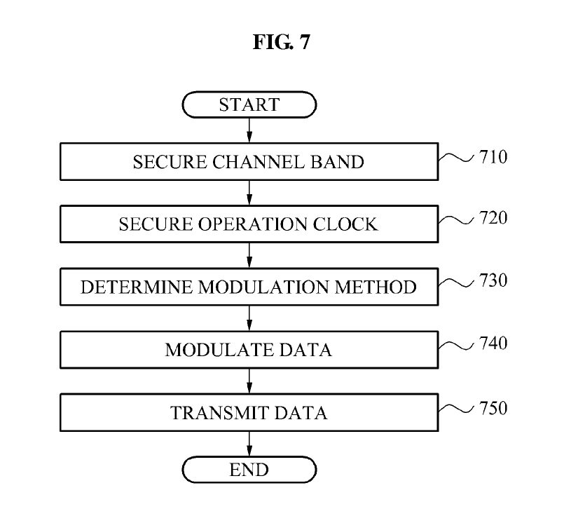

FIG. 7 is a flowchart illustrating steps of a terminal operation method according to an embodiment of the present invention.

In operation 710, the terminal may secure a channel band of a wireless communication network according to a data transmission rate of data to be transmitted using the wireless communication network. According to an aspect, when the data transmission rate of the data to be transmitted is high, the terminal may secure a wide channel band. When the data transmission rate is low, the terminal may secure only a narrow channel band. That is, the terminal may secure the channel band proportional to the data transmission rate.

In operation 720, the terminal may determine an operation clock proportional to the data transmission rate. For example, when the data transmission rate of the data to be transmitted is high, the terminal may determine the operation clock to be high. When the data transmission rate is low, the terminal may determine the operation clock to be low.

In operation 730, the terminal may determine a modulation method according to the data transmission rate. For example, when the data transmission rate is high, the terminal may determine to use a modulation method having a high data transmission rate, such as 8 quadrature amplitude modulation (QAM) or 16 QAM, to transmit the data. When the data transmission rate is low, the terminal may determine to use a modulation method having a low data transmission rate such as binary phase shift key (BPSK).

In operation 740, the terminal may modulate the data according to the determined modulation method.

In operation 750, the terminal may transmit the modulated data to the AP. According to an aspect, the terminal may transmit the data using the secured channel band. Additionally, the terminal may transmit the data with the determined operation clock.

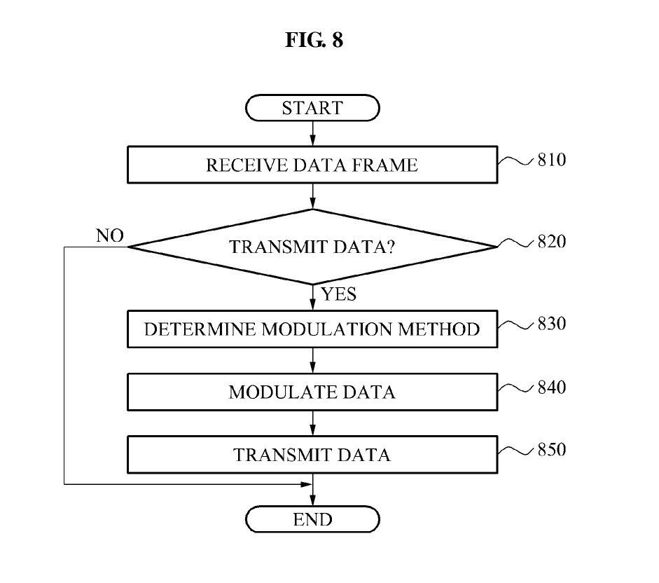

FIG. 8 is a flowchart illustrating steps of a terminal operation method according to another embodiment of the present invention. The terminal may transmit data using a wireless communication network.

In operation 810, the terminal may receive a data frame including a beacon period from an AP. The data frame may include the beacon period and at least one data period. According to an aspect, the beacon period may be used when the AP transmits control information to the terminal. The data period may be used when the terminal transmits data to the AP. The control information may include information on users who will transmit the data to the data period.

In operation 820, the terminal may decode the information on users included in the beacon period, and determine whether to transmit the data in the data period included in the data frame.

According to an aspect, the information on users may define a data transmission rate of the data being transmitted to the data period included in the data frame. In this case, when the data transmission rate of the data to be transmitted from the terminal to the AP is beyond a range of the data transmission rate included in the information on users, the terminal may determine not to transmit the data to the data period.

In operation 830, the terminal may determine the modulation method for the data based on the data transmission rate. According to an aspect, the terminal may secure an operation clock in the data period and a channel band in the data period, based on the data transmission rate. In addition, the terminal may secure the channel operation and the channel band to be proportional to the data transmission rate.

In operation 840, the terminal may modulate the data according to the modulation method.

In operation 850, the terminal may transmit the data in the data period to the AP according to the determined data transmission rate and operation clock in the data period.

According to an aspect, the data frame may include a plurality of data periods. The plurality of data periods may be allocated with respect to different data transmission rates. That is, when the data transmission rate of the data to be transmitted by the terminal is included in a first range, the terminal may select a first data period among the plurality of data periods, determine a first operation clock as the operation of the terminal clock according to the data transmission rate, and transmit the data by securing a first channel band. When the data transmission rate of the data to be transmitted by the terminal is included in a second range, the terminal may select a second data period among the plurality of data periods, determine a second operation clock as the operation clock of the terminal, and transmit the data by securing a second channel band.

According to an aspect, the terminal may operate in the beacon period according to the operation clock of the beacon period, and receive a control signal transmitted from the beacon period. The operation clock of the beacon period is a basic clock determined according to a transmission system including the terminal and the AP. The operation clock of the terminal in the data period may be determined to be a positive number times the basic clock.

According to an aspect, the terminal may transmit the data by sharing the channel band with other terminals during the data period. In this case, a terminal and another terminal transmitting data to the same data period may operate with the same operation clock. That is, when a first terminal and a second terminal respectively use the first channel band and the second channel band in a data period B, the first terminal and the second terminal may transmit data by operating with the same operation clock.

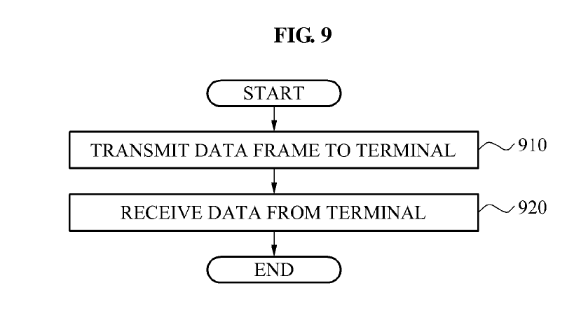

FIG. 9 is a flowchart illustrating steps of an operation method of an AP, according to an embodiment of the present invention. The AP may receive data through a wireless communication network.

In operation 910, the AP may transmit a data frame including a beacon period and a data period to a terminal. The beacon period refers to a time period for the AP to transmit control information to the terminal. The data period refers to a time period for a master device to receive the data from the terminal. The control information may include information on users who may transmit the data to respective data periods.

According to an aspect, the data frame may include a plurality of data periods. In this case, the beacon period may include control information related to the respective data periods.

The terminal may receive the control information in the beacon period. Based on the information on users included in the beacon period, the terminal may determine whether to transmit the data during the data period. For this, the terminal may compare a data transmission rate of data being transmitted to the respective data periods included in the information on users with a data transmission rate of data to be transmitted from the terminal to the AP.

According to an aspect, when the terminal determines to transmit the data to the data period, the terminal may secure a channel band with a bandwidth proportional to the data transmission rate.

According to an aspect, when the terminal determines to transmit the data to the data period, the terminal may determine an operation clock of the terminal in the data period to be an operation clock proportional to the data transmission rate.

According to an aspect, when the terminal determines to transmit the data to the data period, the terminal may determine a modulation method for the data according to the data transmission rate.

In operation 920, the AP may receive from the terminal the data transmitted according to the determined data transmission rate and the determined channel band. Here, the terminal may operate according to the determined operation clock.

According to an aspect, the AP may transmit the data to a plurality of terminals in operation 910. In this case, the AP may receive the data from the plurality of terminals in operation 920. When the AP receives the data from the plurality of terminals during the same data period, the terminals may operate at the same operation clock. Also, the terminals may transmit the data with the same data transmission rate and the same channel band.

According to an aspect, the data frame may include a plurality of data periods. When a data transmission rate of a first terminal and a data transmission rate of a second terminal are different, a data period for the first terminal to transmit data and a data period for the second terminal to transmit data may be different.

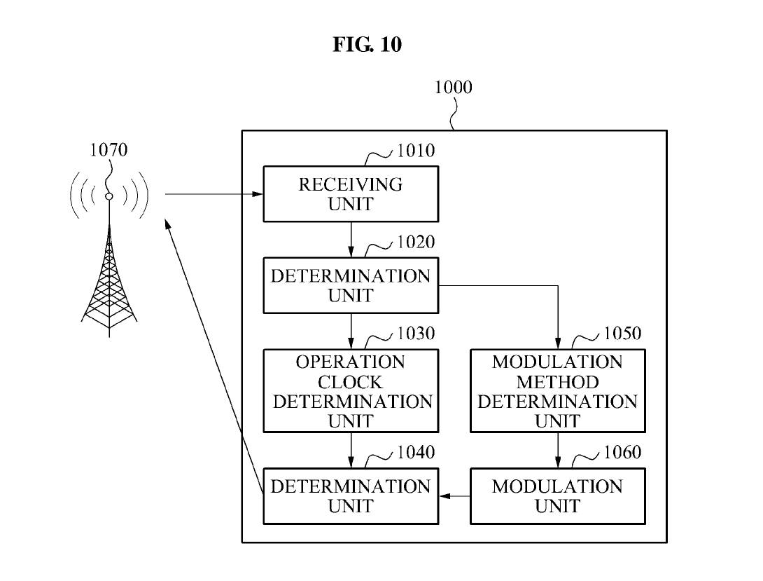

FIG. 10 is a block diagram illustrating a structure of a terminal 1000 according to another embodiment of the present invention. The terminal 1000 may transmit data through a wireless communication network.

A receiving unit 1010 may receive a data frame including a beacon period, from an AP 1070. The data frame may include the beacon period and at least one data period. According to an aspect, the beacon period may be used when an AP transmits control information to a terminal. The data period may be used when the terminal transmits data to the AP. The control information may include information on users who will transmit data to the data period.

A determination unit 1020 may decode the information on users included in the beacon period, and determine whether to transmit the data in the data period included in the data frame.

According to an aspect, the information on users may define a data transmission rate of the data being transmitted to the data period included in the data frame. In this case, when the data transmission rate of the data to be transmitted from a transmission unit 1040 to the AP 1070 is beyond a range of the data transmission rate included in the information on users, the determination unit 1020 may determine not to transmit the data to the data period.

The operation clock determination unit 1030 may determine a data transmission rate based on the information on users. In addition, the operation clock determination unit 1030 may determine an operation clock to be proportional to the data transmission rate.

A modulation method determination unit 1050 may determine a modulation method for the data based on the data transmission rate. According to an aspect, the modulation method determination unit 1050 may secure the operation clock and a channel band in the data period based on the data transmission rate. For example, the modulation method determination unit 1050 may secure the operation clock and the channel band in the data period to be proportional to the data transmission rate.

A modulation unit 1060 may modulate the data according to the determined modulation method.

The transmission unit 1040 may transmit the data the AP 1070 in the data period according to the determined data transmission rate and the operation clock in the data period.

According to an aspect, the data frame may include a plurality of data periods. In this case, the data periods may be allocated with respect to different data transmission rates. That is, when the data transmission rate of data to be transmitted by the transmission unit 1040 is within a first range, the operation clock transmission unit 1030 may select a first data period among the plurality of data periods, determine a first operation clock as the operation clock of the terminal according to the data transmission rate, and transmit the data by securing a first channel band. When the data transmission rate of the data to be transmitted by the terminal is included in a second range, the operation clock transmission unit 1030 may select a second data period among the plurality of data periods, determine a second operation clock as the operation clock of the terminal, and transmit the data by securing a second channel band.

According to an aspect, the receiving unit 1010 may operate in the beacon period according to the operation clock of the beacon period, and receive a control signal transmitted from the beacon period. The operation clock of the beacon period is a basic clock determined according to a transmission system including the terminal 1000 and the AP 1070. The operation clock of the terminal 1000 in the data period may be determined to be a positive number times the basic clock.

According to an aspect, the transmission unit 1040 may transmit the data by sharing the channel band with other terminals during the data period. In this case, the terminal 1000 and another terminal transmitting data to the same data period may operate with the same operation clock. That is, when a first terminal and a second terminal respectively use the first channel band and the second channel band in a data period B, the first terminal and the second terminal may transmit data by operating with the same operation clock.

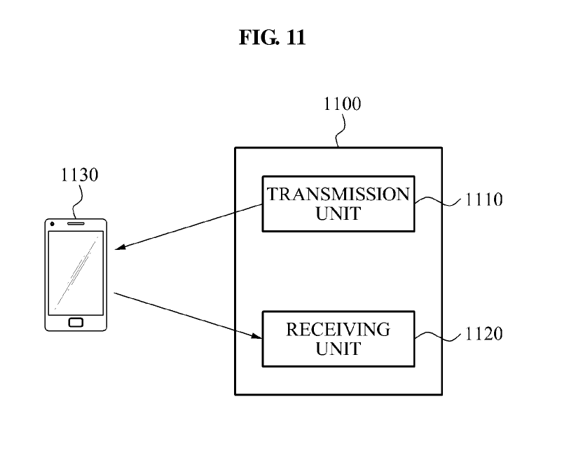

FIG. 11 is a block diagram illustrating a structure of an AP 1100 according to an embodiment of the present invention. The AP 1100 may receive data through a wireless communication network.

A transmission unit 1110 may transmit a data frame including a beacon period and a data period to a terminal 1130. The beacon period refers to a time period for the transmission unit 1110 to transmit control information to the terminal 1130. The data period refers to a time period for a receiving unit 1120 to receive data from the terminal 1130. The control information may include information on users who may transmit data to respective data periods. In particular, the control information may include information on a data transmission rate of the data to be transmitted to the respective data periods. According to an aspect, the data frame may include a plurality of data periods. In this case, the beacon period may include control information with respect to the respective data periods.

The terminal 1130 may receive the control information in the beacon period. Based on the information on users included in the beacon period, the terminal 1130 may determine whether to transmit the data during the data period. For this, the terminal 1130 may compare a data transmission rate of data being transmitted to the respective data periods included in the information on users with a data transmission rate of data to be transmitted from the terminal 1130 to the AP.

According to an aspect, when the terminal 1130 determines to transmit the data to the data period, the terminal 1130 may secure a channel band with a bandwidth proportional to the data transmission rate.

According to an aspect, when the terminal 1130 determines to transmit the data to the data period, the terminal 1130 may determine an operation clock of the terminal 1130 in the data period to be an operation clock proportional to the data transmission rate.

According to an aspect, when the terminal 1130 determines to transmit the data to the data period, the terminal 1130 may determine a modulation method for the data according to the data transmission rate.

The receiving unit 1120 may receive from the terminal 1130 the data transmitted according to the data transmission rate and the determined channel band. Here, the terminal 1130 may operate according to the determined operation clock.

According to an aspect, the transmission unit 1110 may transmit the data to a plurality of terminals. In this case, the receiving unit 120 may receive the data from the plurality of terminals. When the receiving unit 120 receives the data from the plurality of terminals during the same data period, the terminals may operate at the same operation clock. Also, the terminals may transmit the data with the same data transmission rate and the same channel band.

According to an aspect, the data frame may include a plurality of data periods. When a data transmission rate of a first terminal and a data transmission rate of a second terminal are different, a data period for the first terminal to transmit data and a data period for the second terminal to transmit data may be different.

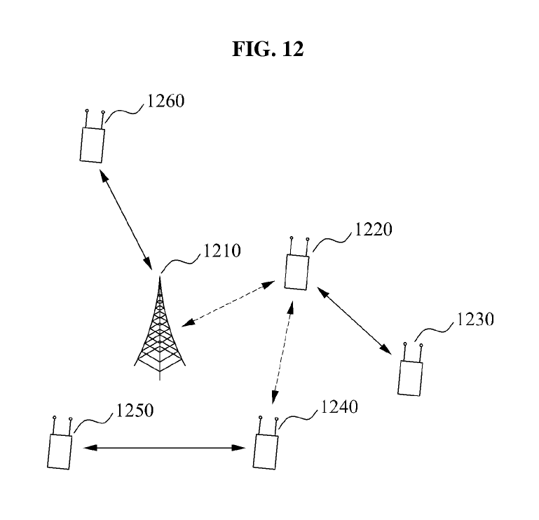

FIG. 12 is a diagram illustrating a wireless resource allocation system according to an embodiment of the present invention.

The wireless resource allocation system may include an AP 1210, and a plurality of terminals 1220, 1230, 1240, 1250, and 1260. A personal area network (PAN) coordinator (PNC) forming a PAN may be used as the AP 1210. The wireless resource allocation system may perform communication in a millimeter wave band. In this case, the wireless resource allocation system may transmit radio waves in only a particular direction using a directional antenna.

When the terminals 1220, 1230, 1240, 1250, and 1260 use omni-directional antennas, data transmitted between the first terminal 1220 and the second terminal 1230 may be transmitted to the other terminals 1240, 1250, and 1260, operating as interference. Therefore, wireless resources allocated to a first terminal pair including the terminals 1220 and 1230 may not be allocated to a second terminal pair including the terminals 1240 and 1250.

In the wireless resource allocation system shown in FIG. 12, the terminals 1220, 1230, 1240, 1250, and 1260 may use directional antennas. In this case, the terminals 1220 and 1230 included in the first terminal pair may transmit data only with respect to each other but not to the other terminals 1240, 1250, and 1260. In this case, the AP 1210 may allocate the wireless resources allocated to the first terminal pair again to the second terminal pair. Therefore, the terminals 1240 and 1250 included in the second terminal pair may transmit data using same wireless resources as the wireless resources allocated to the first terminal pair.

In the following description, in a case in which the same wireless resources are allocated to the first terminal pair and the second terminal pair, when data transmitted from the first terminal pair and the second terminal pair respectively including the terminals 1220 and 1230 and the terminals 1240 and 1250 do not collide, it will be described that wireless channels of the first terminal pair and the second terminal pair do not collide. When the data transmitted from the first terminal pair and the second terminal pair collide, it will be described that the wireless channels of the first terminal pair and the second terminal pair collide each other.

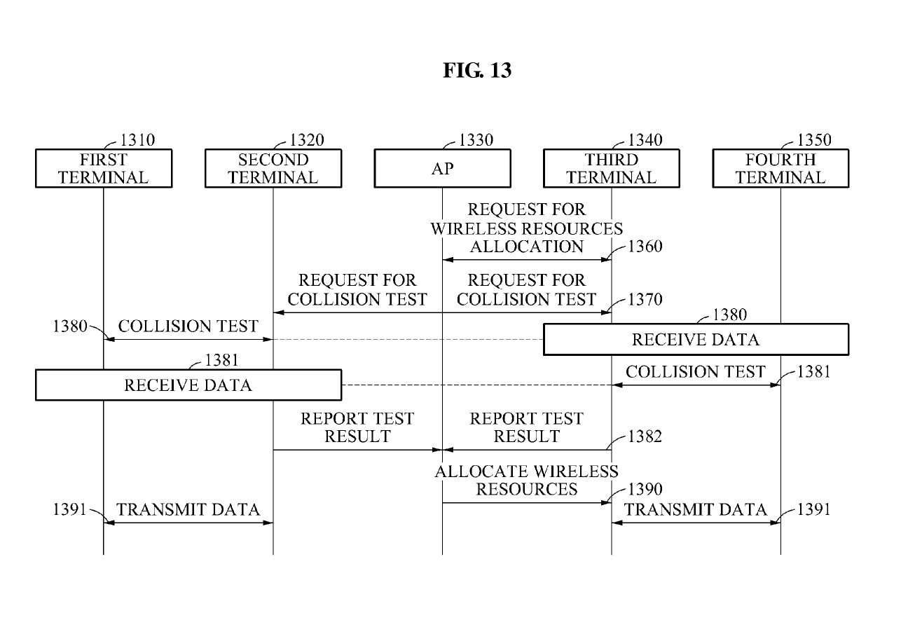

FIG. 13 is a flowchart illustrating steps of a wireless resource allocation method according to an embodiment of the present invention.

In FIG. 13, a first terminal 1310 and a second terminal 1320 form a first terminal pair while a third terminal 1340 and a fourth terminal 1350 form a second terminal pair. The terminals 1310 and 1320 of the first terminal pair are allocated with wireless resources from an AP 1330 and transmit data with each other using the wireless resources.

In operation 1360, the third terminal 1340 included in the second terminal pair may request the AP 1330 for allocation of wireless resources. The AP 1330 receives the request for allocation of wireless resources. When the AP 1330 is capable of determining whether a wireless channel of the first terminal pair and a wireless channel of the second terminal pair collide with each other, the AP 1330 may allocate wireless resources considering whether the wireless channels collide. Specifically, when the wireless channels of the first terminal pair and the second terminal pair collide with each other, the AP 1330 may allocate, to the second terminal pair, wireless resources different from wireless resources allocated to the first terminal pair. Conversely, when the wireless channels do not collide, the AP 1330 may allocate, to the second terminal pair, wireless resources the same as wireless resources allocated to the first terminal pair.

Hereinafter, a method for the AP 1330 to determine whether the wireless channels of the terminal pairs collide with each other will be described in detail through operations 1370 to 1382.

In operation 1370, the AP 1330 may request a collision test with respect to the terminals 1310 and 1320 included in the first terminal pair and the terminals 1340 and 1350 included in the second terminal pair. The collision test refers to a procedure of testing whether data transmitted by the terminal pairs including the terminal pairs 1310, 1320, 1340, and 1350 collide with each other.

In operation 1380, the terminals 1310 and 1320 of the first terminal pair may transmit data to each other. The terminals 1340 and 1350 of the second terminal pair may receive the data from the terminals 1310 and 1320 of the first terminal pair. When the terminals 1340 and 1350 of the second terminal pair receive the data from the terminals 1310 and 1320 of the first terminal pair, the wireless channels of the first terminal pair and the second terminal pair are determined to collide with each other.

In operation 1381, the terminals 1340 and 1350 of the second terminal pair may transmit data to each other. The terminals 1310 and 1320 of the first terminal pair may receive the data from the terminals 1340 and 1350 of the second terminal pair. When the terminals 1310 and 1320 of the first terminal pair receive the data from the terminals 1340 and 1350 of the second terminal pair, the wireless channels of the first terminal pair and the second terminal pair are determined to collide with each other.

In operation 1382, the terminals 1310 and 1320 of the first terminal pair and the terminals 1340 and 1350 of the second terminal pair may report a test result to the AP 1330, the test result showing whether the terminals 1310, 1320, 1340, and 1350 have received data from terminals of other terminal pairs.

In operation 1390, the AP 1330 may allocate wireless resources to the terminals 1340 and 1350 of the second terminal pair by referencing the test result. According to an aspect, when the wireless channels of the first terminal pair and the second terminal pair do not collide, the AP 1330 may allocate, to the second terminal pair, wireless resources the same as wireless resources allocated to the first terminal pair. When the wireless channels collide, the AP 1330 may allocate, to the second terminal pair, wireless resources different from the wireless resources allocated to the first terminal pair.

In operation 1391, the terminal pairs 1310 and 1320 of the first terminal pair may transmit data to each other using the wireless resources and the terminals 1340 and 1350 of the second terminal pair may transmit data to each other using the wireless resources.

In operation 1391, when the first terminal pair and the second terminal pair use different wireless resources, the terminals 1310 and 1320 of the first terminal pair and the terminals 1340 and 1350 of the second terminal pair may transmit data to one another without interference.

Even when the first terminal pair and the second terminal pair use the same wireless resources, since the wireless channels of the terminal pairs do not collide with each other, the terminals 1310 and 1320 of the first terminal pair and the terminals 1340 and 1350 of the second terminal pair may transmit data to one another without interference.

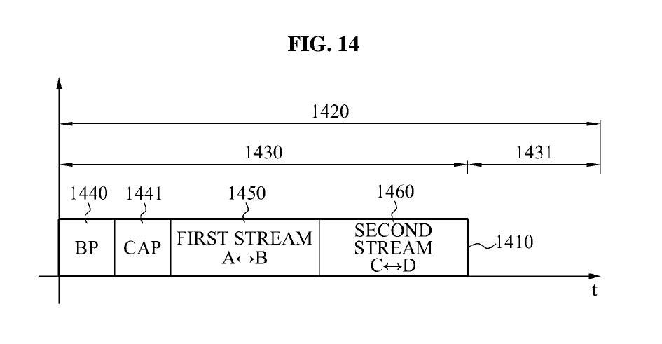

FIG. 14 is a diagram illustrating a structure of a data frame 1410 according to an embodiment of the present invention.

The data frame 1410 shown in FIG. 14 may be commonly used by wireless resource allocation systems according to embodiments of the present invention. The data frame 1410 is defined for a predetermined time period 1420. The data frame 1410 may include a control signal region such as a beacon period (BP) 1440 and a contention access period (CAP) 1441, and a data region to transmit a first stream, a second stream, and the like. Here, a first stream region 1450 refers to wireless resources to transmit data between a terminal A and a terminal B. A second stream region 1460 refers to wireless resources to transmit data between a terminal C and a terminal D. Since the terminals A and B and terminals C and D use different wireless resources, respectively, data may be performed without interference with each other.

The data frame 1410 may be used for only a partial time period 1430 out of an entire time period 1420, whereas a remaining time period 1431 may remain unused.

When a new terminal pair requests an AP for allocation of wireless resources, the AP may allocate the remaining time period 1431 to the new terminal pair. When an amount of the wireless resources requested by the new terminal pair is greater than the remaining time period 1431, the AP may perform a collision test and, according to a test result, allocate wireless resources same as wireless resources 1450 and 1460 being previously allocated, with respect to the new terminal pair.

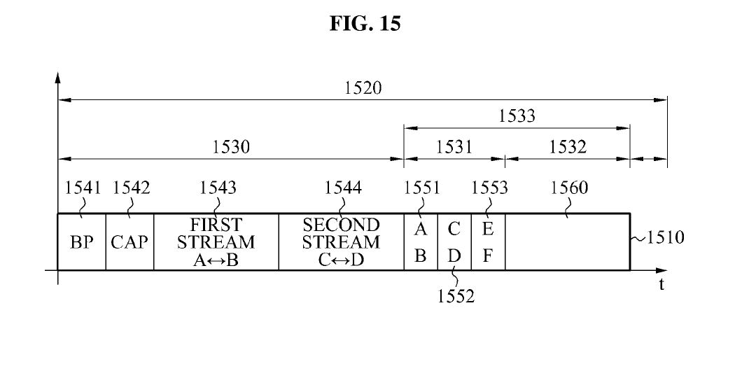

FIG. 15 is a diagram illustrating a structure of a data frame 1510 including interference measurement periods 1551, 1552, and 1553, according to an embodiment of the present invention.

The data frame 1510 may include control information regions 1541 and 1542, and data region 1543 and 1544. Besides, the data frame 1510 may further include interference measurement periods 1551, 1552, and 1553.

The control information region may be a time period for transmitting a control signal such as a BP 1541 and a CAP 1542. The data region may be a time period for transmitting data, such as a first stream region 1543 and a second stream region 1544. The first stream region 1543 may be wireless resources for transmitting data between a terminal A and a terminal B. The second stream region 1544 may be wireless resources for transmitting data between a terminal C and a terminal D.

The AP allocates the interference measurement periods 1551, 1552, and 1553 to a partial region 1531 of a time period 1533 which is not conventionally used. The first interference measurement period 1551 may be a time period for the terminals A and B included in a first terminal pair to transmit data to each other. In this case, all of a terminal C, a terminal D, a terminal E, and a terminal F may receive data from the terminal A or the terminal B.

The second interference measurement period 1552 may be a time period for the terminals C and D included in a second terminal pair to transmit data to each other. In this case, all of the terminal A, the terminal B, the terminal E, and the terminal F may receive data from the terminal C or the terminal D.

The third interference measurement period 1553 may be a time period for the terminals E and F included in a third terminal pair to transmit data to each other. The terminals E and F, to which the wireless resources have not yet been allocated by the AP, may be allocated with the wireless resources according to a result of the collision test. In this case, all of the terminal A, the terminal B, the terminal C, and the terminal D may receive data from the terminal E or the terminal F.

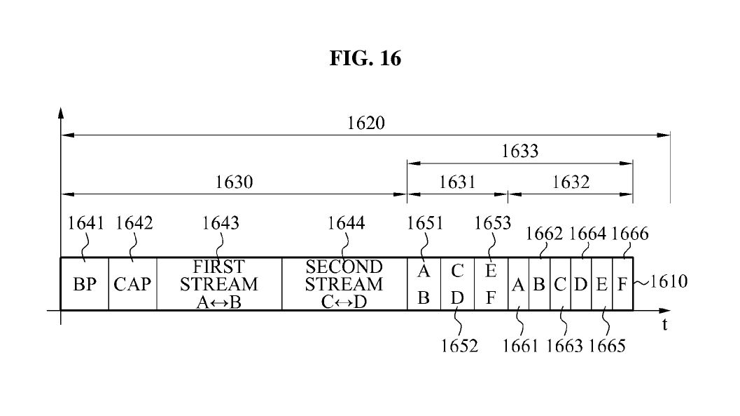

A part 1560 of the data frame 1510 has not been used yet. The time period corresponding to the part 1560 will be described in detail with reference to FIG. 16.

FIG. 16 is a diagram illustrating a structure of a data frame 1610 including an interference report period 1632, according to an embodiment of the present invention.

The data frame 1610 may include control information regions 1641 and 1642, and data region 1643 and 1644. Besides, the data frame 1610 may further include an interference measurement period 1631 and an interference report period 1632. The control information regions 1641 and 1642 and the data regions 1643 and 1644 may be time periods 1630 corresponding to a conventional data frame. The interference measurement period 1631 and the interference report period 1632 may be time periods 1633 not used in a conventional frame.

The interference measurement period 1631 may include time periods 1651, 1652, and 1653 corresponding to respective terminal pairs. The terminal pairs may transmit data to one another during the corresponding time periods 1651, 1652, and 1653 and receive data from other terminal pairs during other time periods. Here, whether the terminals have received the data from other terminal pairs is derived as a result of the collision test.

The interference report period 1632 refers to a time period reporting whether the terminals have received the data from other terminal pairs to the AP. The interference report period 1632 may include time periods 1661, 1662, 1663, 1664, 1665, and 1666 corresponding to the respective terminals. The terminals may transmit, to the AP, a result of the collision test, that is, whether terminals have received the data from other terminal pairs during the corresponding time periods 1661, 1662, 1663, 1664, 1665, and 1666.

The AP may receive the result of the collision test from the terminals and allocate the wireless resources to a new terminal pair including terminals E and F according to the result. According to an aspect, when a particular terminal receives data from another terminal pair, the AP may determine that a wireless channel of a terminal pair including the particular terminal and a wireless channel of the terminal pair transmitting the data collide with each other, and allocate different wireless resources to the terminal pairs. Conversely, when the particular terminal has not received data from another terminal pair, the AP may determine the wireless channel of the terminal pair including the particular terminal and the wireless channel of the terminal pair transmitting the data do not collide, and allocate the same wireless resources.

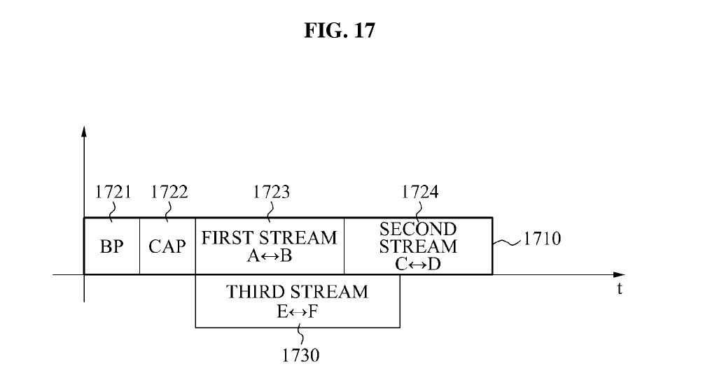

FIG. 17 is a diagram illustrating a structure of a data frame 1710 to which overlapped wireless resources are allocated, according to an embodiment of the present invention.

The data frame 1710 may includes control information regions 1721 and 1722 and data regions 1723, 1724, and 1730 to transmit data among terminal pairs. When a wireless resource of a first terminal pair including a terminal A and a terminal B and a wireless channel of a second terminal pair including a terminal C and a terminal D collide each other, an AP may allocate different wireless resources, for example temporally different wireless resources in the embodiment of FIG. 17, to the first terminal pair and the second terminal pair as shown in FIG. 17.

When the wireless channel of the terminal pair including the terminal A and the terminal B and a wireless channel of a third terminal pair including a terminal E and a terminal F do not collide, the AP may allocate the same wireless resources, for example temporally same wireless resources in the embodiment of FIG. 17, to the first terminal pair and the third terminal pair as shown in FIG. 17.

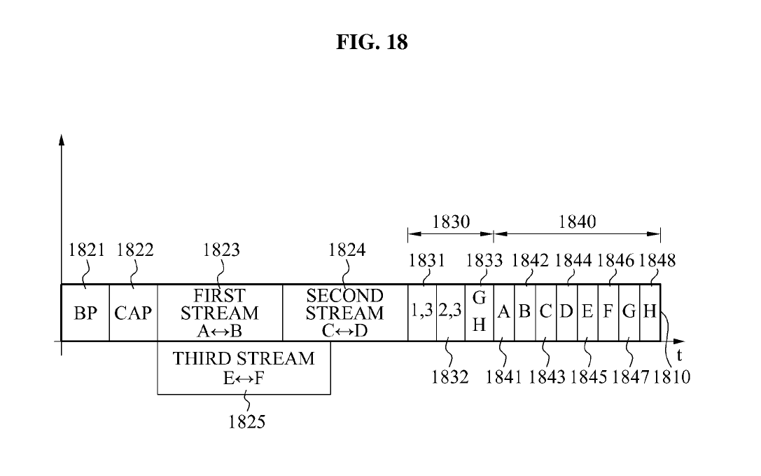

FIG. 18 is a diagram illustrating an interference measurement period 1830 and an interference report period 1840 included in a data frame 1810 to which overlapped wireless resources are allocated, according to an embodiment of the present invention.

The data frame 1810 may include control information regions 1821 and 1822 and data regions 1823, 1824, and 1825 to transmit data. Also, the data frame 1810 may further include an interference measurement region 1830 and an interference report region 1840.

The interference measurement region 1830 may include time periods 1831, 1832, and 1833 corresponding to terminal pairs. During a first interference measurement time period 1831, a terminal A, a terminal B, a terminal E, and a terminal F included in a first terminal pair and a third terminal pair may transmit data. In this case, terminals C, D, G, and H not included in the first terminal pair and the third terminal pair may receive data fro the terminals A, B, E, and F.

During a second interference measurement time period 1832, the terminals C, D, E, and F included in the second terminal pair and the third terminal pair may transmit data. In this case, the terminals A, B, G and H not included in the second terminal pair and the third terminal pair may receive data from the terminals C, D, E, and F.

During a third interference measurement time period 1833, the terminals G and H included in a fourth terminal pair that requests an AP for allocation of wireless resources may transmit data to each other. Other terminals A, B, C, D, E, and F may receive data from the terminals G and H.

The interference report time period 1840 may include time periods 1841, 1842, 1843, 1844, 1845, 1846, 1847, and 1848 corresponding to the terminals. The terminals may transmit, to the AP, a result of the collision test, that is, whether the terminals have received data from other terminal pairs during the time periods 1841, 1842, 1843, 1844, 1845, 1846, 1847, and 1848.

The AP may receive the result of collision test from the respective terminals, and allocate wireless resources to a new terminal pair including terminals G and H according to the received result. According to an aspect, when a particular terminal received data from different terminal pairs, the AP may determine that a wireless channel of a terminal pair including the particular terminal and a wireless channel of the terminal pair transmitting the data collide with each other, and accordingly allocate different wireless resources to the respective terminal pairs. Conversely, when the particular terminal failed to receive data from another terminal pair, the AP may determine that the wireless channel of the terminal pair including the particular terminal and the wireless channel of the terminal pair transmitting the data do not collide with each other, and accordingly allocate same wireless resources.

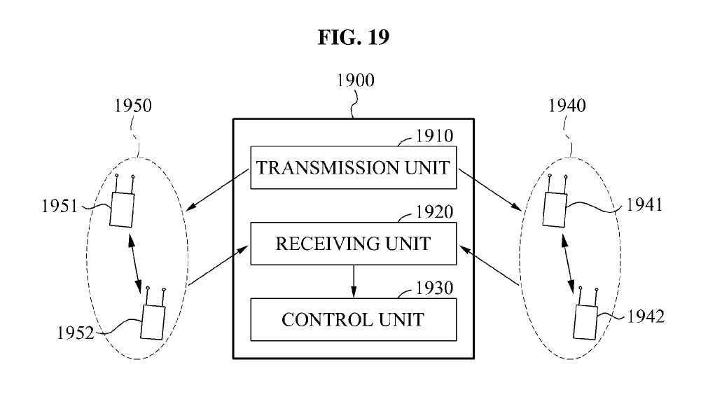

FIG. 19 is a block diagram illustrating a structure of an access point according to an embodiment of the present invention.

The AP 1900 includes a transmission unit 1910, a receiving unit 1920, and a control unit 1930.

The AP 1900 allocates wireless resources to a second terminal pair 1950. Terminals 1951 and 1952 included in the second terminal pair may transmit data using the wireless resources.

The receiving unit 1910 may receive a request for allocation of wireless resources from any one of terminals 1941 and 1942 included in a first terminal pair 1940. The AP 1900 may perform a collision test to determine wireless resources to be allocated to the first terminal pair 1940. Here, all of the terminals 1941 and 1942 included in the first terminal pair 1940 and the terminals 1951 and 1952 included in the second terminal pair 1950 may use a directional antenna and therefore transmit or receive data only in a particular direction.

The transmission unit 1920 may transmit a request for channel measurement, that is, a request for collision test to the terminals 1941 and 1942 included in the first terminal pair 1940 and the terminals 1951 and 1952 included in the second terminal pair 1950 which transmit data using the wireless resources allocated from the AP 1900. When transmitting the request for channel measurement, the transmission unit 1920 may include the request in a control information region included in a data frame transmitted to the terminals 1941, 1942, 1951, and 1952.

The terminal pairs 1940 and 1950 may transmit data to each other according to the request for collision test. According to an aspect, the request for collision test may include information on a time period for transmitting data to the terminal pairs 1940 and 1950. The terminals 1941 and 1942 included in the first terminal pair 1940 may receive the information on the first time period and transmit data during the first time period. The terminals 1951 and 1952 included in the second terminal pair 1950 may receive the information on the first time period and receive data from the terminals 1941 and 1942 included in the first terminal pair 1940 during the first time period. The terminals 1951 and 1952 included in the second terminal pair 1950 may receive information on a second time period and transmit data during the second time period. The terminals 1941 and 1942 included in the first terminal pair 1940 may receive the information on the second time period and receive data from the terminals 1951 and 1952 included in the second terminal pair 1950 during the second time period. The first time period and the second time period may not temporally overlap.

When the terminals 1941 and 1942 included in the first terminal pair 1940 received data from the terminals 1951 and 1952 included in the second terminal pair 1950, it may be considered that a wireless channel of the first terminal pair 1940 and a wireless channel of the second terminal pair 1950 collide with each other. Also, when the terminals 1951 and 1952 included in the second terminal pair 1950 received data from the terminals 1941 and 1942 included in the first terminal pair 1940, the wireless channel of the first terminal pair 1940 and the wireless channel of the second terminal pair 1950 may be considered to collide with each other.

In response to the request for channel measurement, the receiving unit 1910 may receive a report on whether the wireless channel of the first terminal pair 1940 and the wireless channel of the second terminal pair 1950 collide with each other, from the terminals 1941 and 1942 included in the first terminal pair 1940 and the terminals 1951 and 1952 included in the second terminal pair 1950.

The control unit 1930 may allocate the wireless resources to the first terminal pair 1940 based on a collision state between the wireless channel of the first terminal pair 840 and the wireless channel of the second terminal pair 1950, reported by the terminals 1941 and 1942 included in the first terminal pair 1940 and the terminals 1951 and 1952 included in the second terminal pair 1950.

When the channel of the first terminal pair 1940 and the wireless channel of the second terminal pair 1950 do not collide, the control unit 1930 may allocate the first terminal pair 1940 with same wireless resources, in particular, temporally same wireless resources as wireless resources allocated to the second terminal pair 1950. When the wireless channel of the first terminal pair 1940 and the wireless channel of the second terminal pair 1950 collide with each other, the control unit 1930 may allocate the first terminal pair 1940 with different wireless resources from the wireless resources allocated to the second terminal pair 1950.

The terminals 1941 and 1942 included in the first terminal pair 1940 may transmit data with each other using the allocated wireless resources. Also, the terminals 1951 and 1952 included in the second terminal pair 1950 may transmit data with each other using the allocated wireless resources.

When the terminals 1941 and 1942 included in the first terminal pair 1940 and the terminals 1951 and 1952 included in the second terminal pair 1950 use different wireless resources from each other, the terminals 1941 and 1942 and the terminals 1951 and 1952 may perform data transmission without interference.

When the terminals 1941 and 1942 and the terminals 1951 and 1952 use the same wireless resources as well, since the wireless channels of the respective terminal pairs 1940 and 1950 do not collide with each other, data transmission may be performed without interference between the terminals 1941 and 1942 and the terminals 1951 and 1952.

After allocation of the wireless resources to the first terminal pair 1940 and the second terminal pair 1950 is completed, the receiving unit 1910 may receive a request for allocation of wireless resources from terminals included in a third terminal pair.

In this case, the transmission unit 1920 may transmit information on a time for performing collision test by the terminal pairs to the terminal pairs. That is, when a same time period is allocated to the first terminal pair 1940 and the second terminal pair 1950, the information on the time for performing collision test by the respective terminal pairs may include information on a third time period and a fourth time period. Here, during the third time period, the terminals included in the third terminal pair may perform collision test by transmitting data, and the terminals 1941, 1942, 1951, and 1952 of the first terminal pair 1940 and the second terminal pair 1950 may receive the data from the terminals included in the third terminal pair. During the fourth time period, the terminals 1941, 1942, 1951, and 1952 of the first terminal pair 1940 and the second terminal pair 1950 may perform collision test by transmitting data, and the terminals included in the third terminal pair may receive the data from the terminals 1941, 1942, 1951, and 1952 of the first terminal pair 1940 and the second terminal pair 1950.

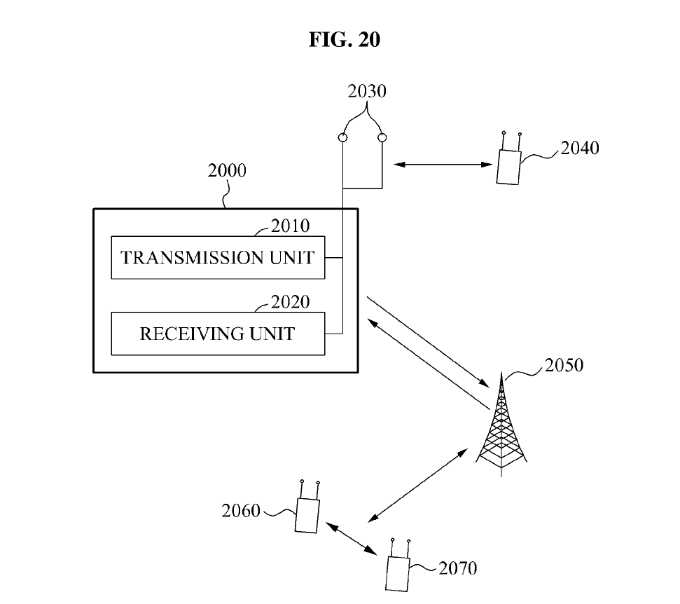

FIG. 20 is a block diagram illustrating a structure of a terminal 2000 maintaining connection with an AP, according to an embodiment of the present invention.

The terminal 2000 may include a transmission unit 2010 and a receiving unit 2020.

The terminal 2000 may be included in a first terminal pair together with a second terminal 2040. The terminal 2000 may transmit data to the second terminal 2040 or receive data from the second terminal 2040. For example, the terminal 2000 may transmit data only in a particular direction in a focusing manner using a directional antenna 2030. Therefore, when terminals 2060 and 2070 included in a second terminal pair are located in a different direction from the second terminal 2040, the terminal 2000 may not transmit an interference signal to the terminals included in the second terminal pair or not receive the interference signal from the terminals included in the second terminal pair.

That is, when a wireless channel between the terminals 2000 and 2040 included in the first terminal pair does not collide with a wireless channel between the terminals 2060 and 2070 included in the second terminal pair, the terminals 2000 and 2040 and the terminals 2060 and 2070 may communicate with each other without interference.

The terminals 2000 and 2040 included in the first terminal pair may be allocated with wireless resources by an AP 2050, and transmit data to opponent terminals 2000 and 2040 using the wireless resources.

When the terminals 2060 and 2070 included in the second terminal pair request the AP 2050 for allocation of the wireless resources, the AP 2050 may perform collision test to determine whether to allocate the terminals 2060 and 2070 included in the second terminal pair or determine the wireless resources to be allocated to the terminals 2060 and 2070.

Here, the receiving unit 2020 may receive a request for collision test from the AP 2050. The request for collision test may include information on a first time terminal during which the terminals 2000 and 2040 included in the first terminal pair transmit data and information on a second time period during which the terminals 2060 and 2070 included in the second terminal pair transmit data. The first time period and the second time period may be different from each other and not overlap.

The transmission unit 2010 may transmit data to the second terminal 2040 during the first time period. In addition, the receiving unit 2010 may receive data from the second terminal 2040 during the first time period. During the first time period, the terminals 2060 and 2070 included in the second terminal pair may receive data from the terminal 2000 and the second terminal 2040.

During the second time period, the terminals 2060 and 2070 included in the second terminal pair may transmit and receive data with respect to each other. The receiving unit 2020 may receive the data from the terminals 2060 and 2070 included in the second terminal pair during the second time period.

The transmission unit 2010 may transmit, to the AP 2050, whether the receiving unit 2020 received the data from the terminals 2060 and 2070 included in the second terminal pair during the second time period. When the receiving unit 2020 received the data from the terminals 2060 and 2070 during the second time period, the wireless channel between the terminals 2000 and 2040 included in the first terminal pair and the wireless channel between the terminals 2060 and 2070 may be considered to collide with each other.

The AP 2050 may allocate the wireless resources to the second terminal pair according to whether the wireless channel between the terminals 2000 and 2040 included in the first terminal pair and the wireless channel between the terminals 2060 and 2070 included in the second terminal pair collide with each other.

According to an aspect, when the wireless channel of the first terminal pair and the wireless channel of the second terminal pair do not collide, the AP 2050 may allocate the second terminal pair with same wireless resources as wireless resources allocated to the first terminal pair. In addition, when the wireless channels collide with each other, the AP 2050 may allocate the second terminal pair different wireless resources from the wireless resources allocated to the first terminal pair.

The terminals 2000 and 2040 included in the first terminal pair may transmit data to each other using the allocated wireless resources. The terminals 2060 and 2070 included in the second terminal pair may transmit data to each other using the allocated wireless resources.

When the terminals 2000 and 2040 included in the first terminal pair and the terminals 2060 and 2070 included in the second terminal pair use different wireless resources, the terminals 2000 and 2040 included in the first terminal pair and the terminals 2060 and 2070 included in the second terminal pair may transmit data to each other without interference.

Also, when the terminals 2000 and 2040 included in the first terminal pair and the terminals 2060 and 2070 included in the second terminal pair use the same wireless resources as well, the terminals 2000 and 2040 included in the first terminal pair and the terminals 2060 and 2070 included in the second terminal pair may transmit data to each other without interference.

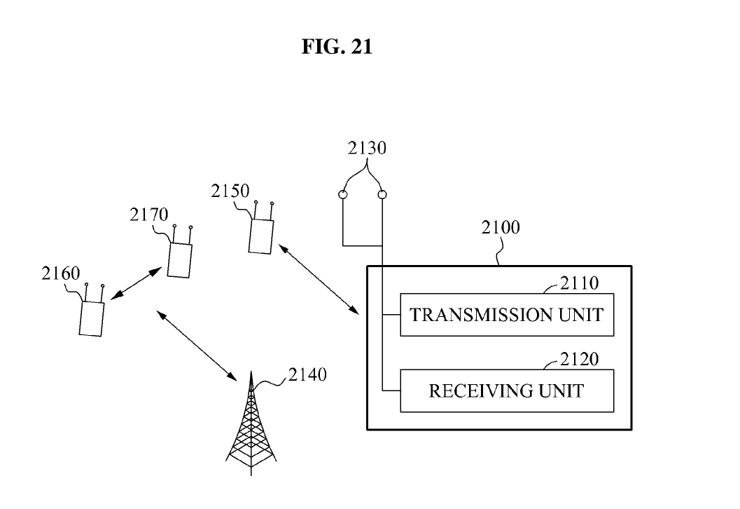

FIG. 21 is a block diagram illustrating a structure of a terminal 2100 trying connection to an AP, according to an embodiment of the present invention.

The terminal 2100 includes a transmission unit 2110 and a receiving unit 2120.

The terminal 2100 may be included in a first terminal pair together with a second terminal 2150. The terminal 2100 may transmit data to the second terminal 2150 or receive data from the second terminal 2150. For example, the terminal 2100 may transmit data only in a particular direction in a focusing manner using a directional antenna 2130. Therefore, when terminals 2160 and 2170 included in a second terminal pair are located in a different direction from the second terminal 2150, the terminal 2100 may not transmit an interference signal to the terminals included in the second terminal pair or not receive the interference signal from the terminals included in the second terminal pair.

The terminals 2160 and 2170 included in the second terminal pair may be allocated with wireless resources by an AP 2140, and transmit data to opponent terminals 2160 and 2170 using the wireless resources.

Any one of the channels 2100 and 2150 included in the first terminal pair may request the AP 2140 for allocation of wireless resources. For example, the transmission unit 2110 may transmit a request for allocation of wireless resources to the AP 2140 for communication with the second terminal 2150.

In this case, the receiving unit 2120 may receive a request for collision test from the AP 2140 in response to the request for allocation of wireless resources. For example, the request for collision test may include information on a first time period and information on a second time period. During the first time period, the terminals 2100 and 2150 included in the first terminal pair transmit data and the terminals 2160 and 2170 included in the second terminal pair receive the data from the terminals 2100 and 2150. During the second time period, the terminals 2160 and 2170 included in the second terminal pair transmit data and the terminals 2100 and 2150 included in the first terminal pair receive the data from the terminals 2160 and 2170. The first time period and the second time period may be different from each other and not overlap.

During the first time period, the transmission unit 2110 may transmit data to the second terminal 2150 or the receiving unit 2120 may receive the data from the second terminal 2150.

During the second time period, the receiving unit 2120 may receive data from the terminals 2160 and 2170 included in the second terminal pair.

The transmission unit 2110 may transmit whether the receiving unit 1020 received the data from the terminals 2160 and 2170 included in the second terminal pair during the second time period, to the AP 2140. When the receiving unit 2120 received the data from the terminals 2160 and 2170 during the second time period, the wireless channel between the terminals 2100 and 2150 included in the first terminal pair and the wireless channel between the terminals 2160 and 2170 included in the second terminal pair may be considered to collide with each other.

The AP 2140 may allocate wireless resources to the first terminal pair according to whether the wireless channel between the terminals 2100 and 2150 included in the first terminal pair and the wireless channel between the terminals 2160 and 2170 included in the second terminal pair collide with each other.

When the wireless channel of the first terminal pair and the wireless channel of the second terminal pair do not collide, the AP 2140 may allocate the first terminal pair with same wireless resources as wireless resources allocated to the second terminal pair. When the wireless channel of the first terminal pair and the wireless channel of the second terminal pair collide, the AP 2140 may allocate the first terminal pair with different wireless resources from the wireless resources allocated to the second terminal pair.

The terminals 2100 and 2150 included in the first terminal pair may transmit data to each other using the allocated wireless resources. The terminals 2160 and 2170 included in the second terminal pair may transmit data to each other using the allocated wireless resources.

When the terminals 2100 and 2150 included in the first terminal pair and the terminals 2160 and 2170 included in the second terminal pair use different wireless resources, the terminals 2100 and 2150 of the first terminal pair and the terminals 2160 and 2170 included in the second terminal pair may transmit data to each other without interference.

Also, when the terminals 2100 and 2150 included in the first terminal pair and the terminals 2160 and 2170 included in the second terminal pair use the same wireless resources as well, the terminals 2100 and 2150 included in the first terminal pair and the terminals 2160 and 2170 included in the second terminal pair may transmit data to each other without interference.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An operation method of a terminal that transmits data through a wireless communication network, the operation method comprising:
securing a channel band of the wireless communication network according to a data transmission rate of data to be transmitted through the wireless communication network; and
transmitting the data using the channel band.

2. The operation method of claim 1, wherein the channel band is proportional to the data transmission rate.

3. The operation method of claim 1, further comprising;
determining an operation clock proportional to the data transmission rate,
wherein the transmitting comprises transmitting the data at the operation clock.

4. The operation method of claim 1, further comprising:
determining a modulation method according to the data transmission rate; and
modulating the data according to the modulation method,
wherein the transmitting comprises transmitting the modulated data.

5. A method of operating a terminal that transmits data through a wireless communication network, the method comprising:
receiving a data frame including a beacon period from an access point (AP);
determining whether to transmit the data in a data period included in the data frame by decoding information on users included in the beacon period;
determining a data transmission rate of the data and an operation clock in the data period, the operation clock proportional to the data transmission rate, based on the information on users when transmitting the data; and
transmitting the data to the AP in the data period according to the data transmission rate and the operation clock in the data period.

6. The operation method of claim 5, further comprising:
determining a modulation method according to the data transmission rate; and
modulating the data according to the modulation method,
wherein the transmitting comprises transmitting the modulated data.

7. The operation method of claim 5, wherein the transmitting comprises transmitting the data with a bandwidth proportional to the data transmission rate.

8. A terminal that transmits data through a wireless communication network, the terminal comprising:
a receiving unit to receive a data frame that includes a beacon period from an access point (AP);
a determination unit to determine whether to transmit the data in a data period included in the data frame by decoding information on users included in the beacon period;
an operation clock determination unit to determine a data transmission rate of the data and an operation clock in the data period, the operation clock proportional to the data transmission rate, based on the information on users when transmitting the data; and
a transmission unit to transmit the data to the AP in the data period according to the data transmission rate and the operation clock in the data period.

9. The terminal of claim 8, further comprising:
a modulation method determination unit to determine a modulation method according to the data transmission rate; and
a modulation unit to modulate the data according to the modulation method,
wherein the transmission unit transmits the modulated data.

10. The terminal of claim 8, wherein the transmission unit transmits the data with a bandwidth proportional to the data transmission rate.
